(19) United States
(12) Patent Application Publication
(10) Pub. No.: US 2024/0314179 A1
(43) Pub. Date: Sep. 19, 2024

(54) Shared Sessions in Artificial Reality Environments

(71) Applicant: Meta Platforms Technologies, LLC, Menlo Park, CA (US)

(72) Inventors: Shir Lene LIM, Kirkland, WA (US); Lionel Laurent REYERO, Lexington, MA (US); Mohamad HAJ YAHIA, Taybeh (IL); Ata DOGAN, Seattle, WA (US)

(21) Appl. No.: 18/183,083

(22) Filed: Mar. 13, 2023

(51) Int. Cl. H04L 65/1093; G06T 19/00; H04L 12/18

(52) U.S. Cl. CPC H04L 65/1093; G06T 19/006; H04L 12/1845; H04L 12/189; G06T 2219/024

(57) ABSTRACT

Aspects of the present disclosure relate to shared sessions in artificial reality environments. Some implementations provide for application-level co-location that uses an application programming interface to connect co-located users (i.e., a local group) within a particular application. Some implementations can detect co-located users using existing proximity detection technologies. The application can make a call to identify the co-located users, generate a shared session for the co-located users specific to that application, and share session data with the co-located users, which can include spatial anchors, scene data, guardian data, etc. Other implementations provide for system-level co-location that allows for frictionless travel between multiple applications. The system can make a session discoverable for co-located devices to join, and to share spatial anchors between them (and, in some cases, scene data and guardian data), without the applications themselves having to create the session and share anchors.

### TECHNICAL FIELD

The present disclosure is directed to sharing session data, at system and application levels, between co-located artificial reality (XR) devices in artificial reality (XR) environments.

### BACKGROUND

Artificial reality (XR) devices are becoming more prevalent. As they become more popular, the applications implemented on such devices are becoming more sophisticated. Augmented reality (AR) applications can provide interactive 3D experiences that combine images of the real-world with virtual objects, while virtual reality (VR) applications can provide an entirely self-contained 3D computer environment. For example, an AR application can be used to superimpose virtual objects over a video feed of a real scene that is observed by a camera. A real-world user in the scene can then make gestures captured by the camera that can provide interactivity between the real-world user and the virtual objects. Mixed reality (MR) systems can allow light to enter a user's eye that is partially generated by a computing system and partially includes light reflected off objects in the real-world. AR, MR, and VR (together XR) experiences can be observed by a user through a head-mounted display (HMD), such as glasses or a headset.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a flow diagram illustrating a process used in some implementations of the present technology for establishing a shared session for an artificial reality application on an application level.

FIG. 6 is a flow diagram illustrating a process performed by various components to establish and join a shared session for an artificial reality application on an application level.

FIG. 7A is a conceptual diagram illustrating an example view on an artificial reality device of a menu of launchable artificial reality applications overlaid on a view of a real-world environment.

FIG. 7B is a conceptual diagram illustrating an example view on a first artificial reality device of a launched artificial reality application overlaid on a view of a real-world environment.

FIG. 7C is a conceptual diagram illustrating an example view on a second artificial reality device of a launched artificial reality application in a shared session with a first artificial reality device.

FIG. 8 is a flow diagram illustrating a process used in some implementations of the present technology for establishing a shared session in an artificial reality environment on a system level.

FIG. 9 is a flow diagram illustrating a process performed by various components to establish and join a shared session in an artificial reality environment on a system level.

FIG. 10A is a conceptual diagram illustrating an example view on a first artificial reality device of a prompt to join a second user in an artificial reality application in a shared session.

FIG. 10B is a conceptual diagram illustrating an example view on a first artificial reality device of a shared session in an artificial reality application.

FIG. 10C is a conceptual diagram illustrating an example view on a first artificial reality device of a prompt to travel with a second user to another artificial reality application in a shared session.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to shared sessions in artificial reality (XR) environments. Some implementations relate to application-level co-location that uses an application programming interface (API) to connect co-located users (i.e., a local group of users) within a particular application. Some implementations can detect co-located XR devices using local detection technologies (e.g., Bluetooth, Bluetooth Low Energy (BLE), network service discovery (NSD), near field communication (NFC) detection, WiFi, ultrasound, virtual private server (VPS), etc.). An application can make a call to identify the co-located XR devices, generate a shared session for the co-located users specific to that application, and share one or more spatial anchors for the session with the co-located XR devices. In some implementations, the co-located XR devices can further share scene data and guardian data with respect to the spatial anchors. In some implementations, the co-located XR devices can be identified by a random identifier, such that no private information is exposed. In some implementations, upon identification of co-located XR devices, the application can automatically place the XR devices in the shared session, while in other implementations, the application can prompt the user to join the shared session.

For example, a first user can put on an XR HMD, start an XR application, and initiate a shared session within the XR application through a series of API calls from the XR application to the system. The first user can tell a second user, a friend in the same room, to launch the same XR application. The second user can put on her XR HMD and navigate to the same XR application. Within the XR application, the second user can see a notification inviting her to join the first user. With one click, the second user can join the session the first user had started. In some implementations, however, the second user can automatically join the shared session with the first user upon launch of the XR application.

Some implementations relate to system-level co-location that allows for frictionless travel between multiple applications. In such implementations, the system can initiate and control session creation and discovery. The system can have the ability to make itself discoverable as a session for co-located devices to join, and to share one or more spatial anchors between them (and, in some implementations, scene data and/or guardian data relative to the spatial anchors). The session established by the system can be requested by one or more XR applications, without the XR applications themselves having to create the session and share anchors. Thus, the system-level co-location can allow users to travel across different XR applications together, without having to recreate sessions and reshare anchors for each XR application.

In another example, a first user can put on her XR HMD, initiate a shared session, and launch an XR application. A second user, in the same room as the first user, can put on his XR HMD and see the first user, the play space (e.g., a guardian), and a preview of the XR application that the first user is in. The second user can walk into the play space and immediately be joined to the shared session with the first user. Both users can then travel between XR applications together, without having to create parties or new shared sessions.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

Conventionally, users need to take manual steps in order to invite, join, and participate in a shared co-located experience. For example, in conventional systems, users have to manually communicate a specific room code to their co-located friends so they can all join the same room. There is no awareness that the users of the applications are physically present together. Aspects of the present disclosure provide a specific improvement in the field of multiuser (e.g., multiplayer) artificial reality (XR) experiences by allowing users to get started in a local multiuser mode faster and with fewer steps. Users can use their XR devices to quickly discover nearby sessions and successfully share all necessary spatial data so that an XR experience can be joined together in a short time. By reducing the number of steps needed to establish a join a co-located session, the user experience is improved and compute resources on the XR devices are conserved (e.g., battery power, processing power, etc.). Thus, the XR devices can commit further resources to rendering the XR experience, thereby improving processing speed and latency.

n addition, when applying system-level shared sessions, some implementations of the disclosed technology allow seamless virtual group travel for a set of co-located users from an instance of an XR application that they are accessing together, to an instance of another XR application. In other words, implementations can facilitate a set of users traveling together from one multiuser experience to another. In conventional systems, users must manually coordinate to move between applications together. For example, to stay together across different applications, users must form a party in one application (i.e., make a formal association between the users indicating to a computing system hosting that application that they should be kept together), close that application, open another application, and reform their party in the other application, in order to experience the applications together. In addition, some XR experiences always require formation of a party in order for a group of users to guarantee that they will be in the same instance of a multiuser session together.

Aspects of the present disclosure address these problems and others by facilitating virtual group travel between XR experiences using a session identifier that can allow a hosting computing system to easily identify the users to keep together as they move between virtual locations in an application or across applications, without requiring reformation of a party or shared session. In some instances, aspects of the present disclosure facilitate virtual group travel between XR experiences on co-located XR devices without requiring formal formation of a party at all. Some implementations can allow users to travel between virtual worlds, levels, or even applications seamlessly, even if such XR destinations are hosted by different computing systems. The implementations described herein are necessarily rooted in computing technology (i.e., XR technology) to overcome a problem specifically arising in the realm of computer networks, e.g., communication and coordination between disparate computing systems hosting different XR destinations (that may be even associated with different developers), without requiring a heavy processing or storage load on a central platform computing system.

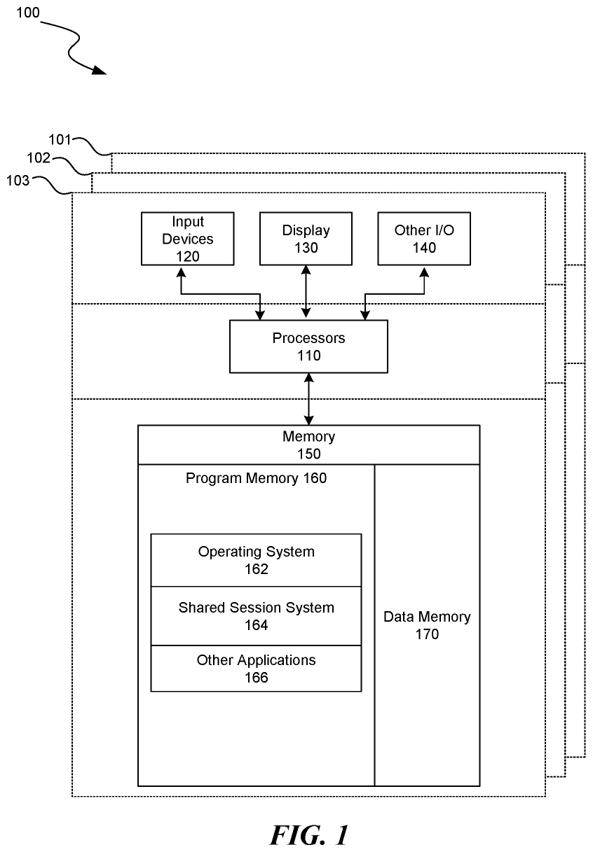

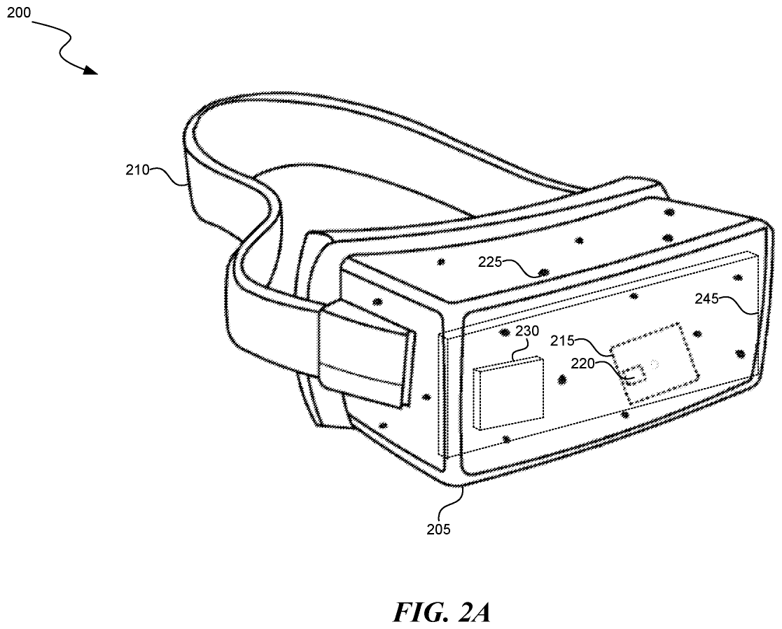

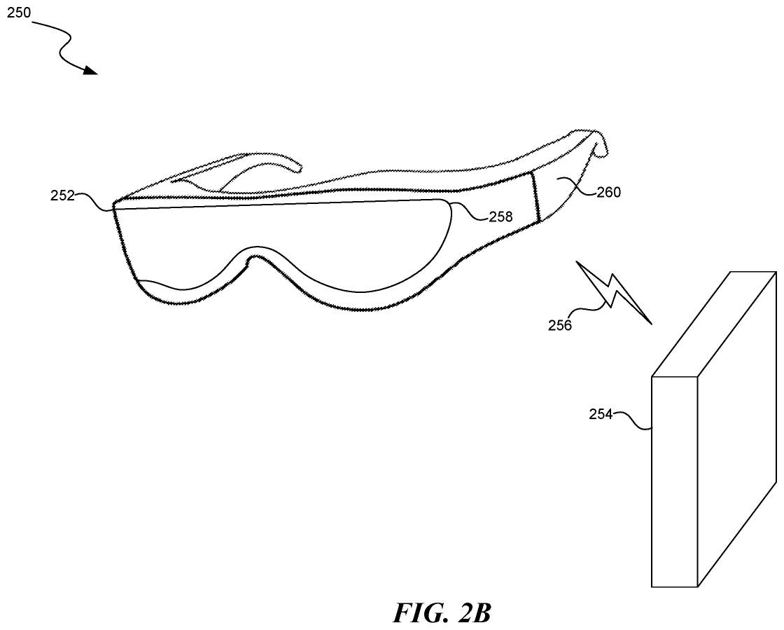

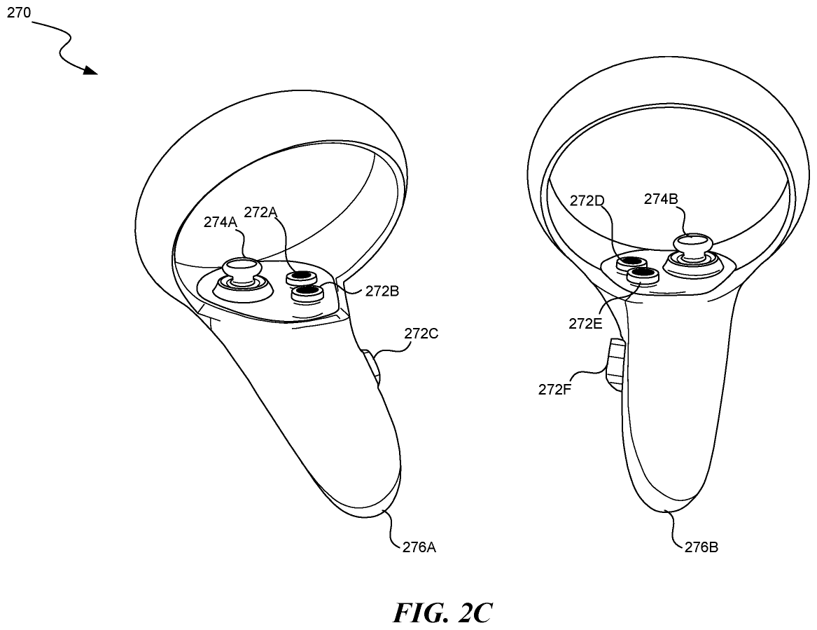

Several implementations are discussed below in more detail in reference to the figures. FIG. 1 is a block diagram illustrating an overview of devices on which some implementations of the disclosed technology can operate. The devices can comprise hardware components of a computing system 100 that can establish a shared session in an artificial reality (XR) environment. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, girds, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, shared session system 164, and other application programs 166. Memory 150 can also include data memory 170 that can include, e.g., XR application data, session data, session identifier data, shared session data, rendering data, input data, discoverability data, communication data, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. The HMD 200 includes a front rigid body 205 and a band 210. The front rigid body 205 includes one or more electronic display elements of an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real world and in an artificial reality environment in three degrees of freedom (3DoF) or six degrees of freedom (6DoF). For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points. Compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

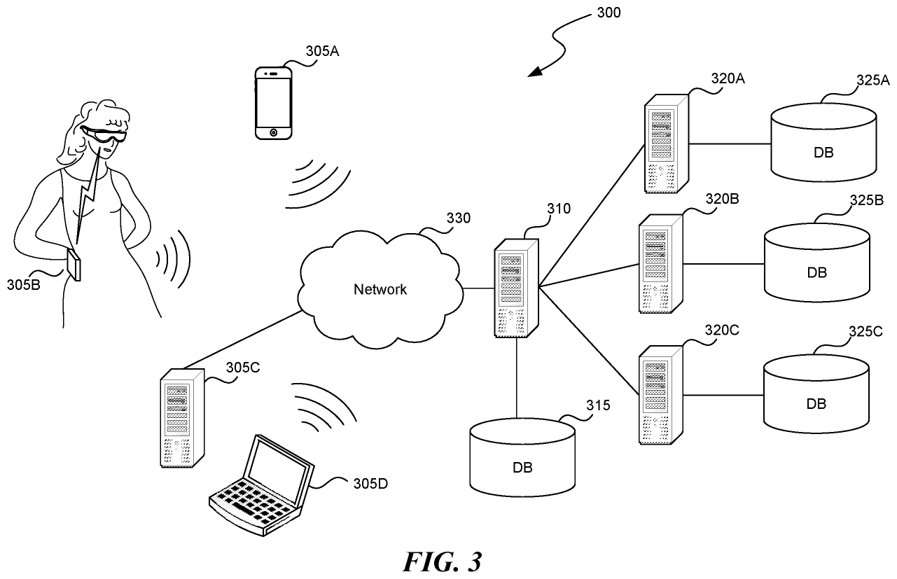

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

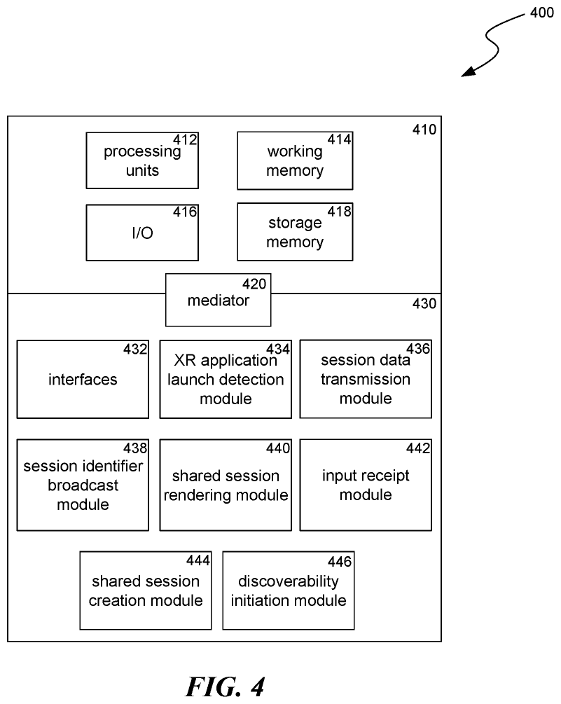

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for establishing a shared session in an artificial reality (XR) environment. Specialized components 430 can include XR application launch detection module 434, session data transmission module 436, session identifier broadcast module 438, shared session rendering module 440, input receipt module 442, shared session creation module 444, discoverability initiation module 446, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

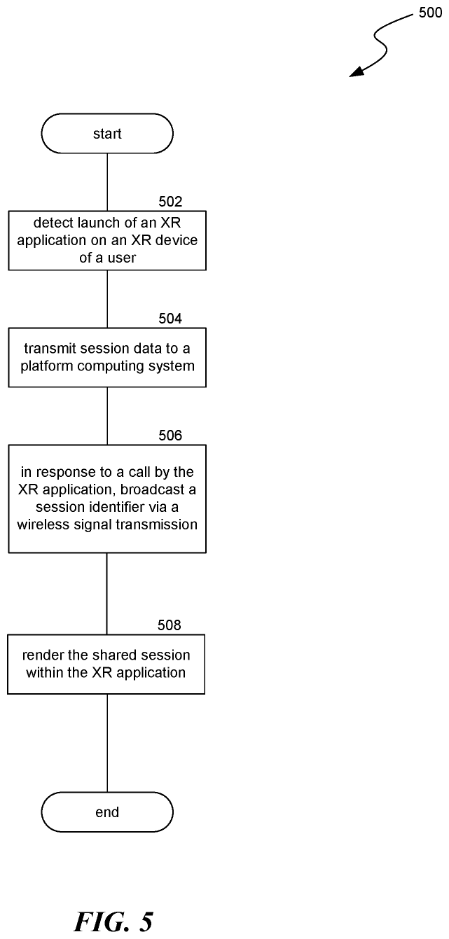

XR application launch detection module 434 can detect launch of a multiuser artificial reality (XR) application on an XR device, such as an XR head-mounted display (HMD) (e.g., XR HMD 200 of FIG. 2A and/or XR HMD 252 of FIG. 2B). In some implementations, XR application launch detection module 434 can detect launch of the XR application based on explicit user input, such as a selection of the XR application from a virtual menu or prompt, via a gesture or via one or more controllers (e.g., controller 276A and/or controller 276B of FIG. 2C). In some implementations, XR application launch detection module 434 can detect an automatic launch of the XR application, such as by a user entering a particular guardian (i.e., a defined XR usage space, which may have a boundary which can trigger warnings or other system actions if a user crosses the boundary when in an XR experience), which can automatically cause launch of an XR application (e.g., the XR application mostly frequently used within the guardian, the XR application last accessed within the guardian, etc.). Upon launch, the XR application can make application programming interface (API) calls to XR application launch detection module 434 to create a shared session for the XR device. Further details regarding detecting launch of an XR application on an XR device are described herein with respect to block 502 of FIG. 5.

Session data transmission module 436 can generate and transmit session data for the shared session to a platform computing system (e.g., a remote server storing and managing shared session data). Session data transmission module 436 can transmit the session data to the platform computing system over any suitable network, such as network 330 of FIG. 3. In some implementations, the session data can include one or more spatial anchors for a real-world environment surrounding the XR device. The spatial anchors can be points in the real-world environment that the XR device can detect and follow across sessions. As long as the real-world environment does not change, the spatial anchors can persist and be shareable to other XR devices accessing XR applications from within the real-world environment. Thus, XR devices within a common real-world environment can have common reference points. In some implementations, the XR device can capture and/or create the spatial anchors for the real-world environment by, for example, scanning the real-world environment, identifying unmovable features (or features unlikely to be moved) in the real-world environment, and saving them as reference points. In some implementations, the XR device can obtain previously captured spatial anchors from local storage, from another XR device, and/or from a platform computing system or other computing system on the cloud, as described further herein. In some implementations, the session data can further include scene data (e.g., identifications and position data for real-world elements such as walls, doorways, stairs, windows, floor, ceiling, furniture, or other objects) and/or guardian data (e.g., border position, related applications, triggering events, etc.) stored with reference to the one or more spatial anchors, as described further herein. In some implementations, the session data can further include a session identifier, such as a unique string of characters that can be used by the platform computing system to store and/or retrieve the session data. In some implementations, session data transmission module 436 can generate the session identifier, while in other implementations, the platform computing system and assign the session identifier and transmit the session identifier back to the XR device for reference. Further details regarding transmitting session data to a platform computing system are described herein with respect to block 504 of FIG. 5.

Session identifier broadcast module 438 can receive an API call from the XR application to transmit or broadcast the session identifier via a wireless signal transmission, such as over Bluetooth, Bluetooth Low Energy (BLE), near field communication (NFC), WiFi, etc. In some implementations, session identifier broadcast module 438 can transmit the session identifier directly to another XR device with which it is co-located, such as based on a determination that the other XR device is on an access list of XR devices permitted (e.g., selected by a user of the XR device) to access the session identifier. In some implementations, session identifier broadcast module 438 can broadcast the session identifier publicly, such that any other XR devices within a coverage area of the wireless signal transmission can obtain the session identifier. In other implementations, session identifier broadcast module 438 can broadcast the session identifier in an encrypted format (or applying other privacy or security restrictions), such that only other XR devices with an access key, credentials, or other access mechanism can obtain the session identifier. Upon receipt of the session identifier, another co-located XR device can launch the same XR application, obtain the session data using the session identifier, and join the shared session. Further details regarding broadcasting a session identifier via a wireless signal transmission are described herein with respect to block 506 of FIG. 5.

Shared session rendering module 440 can render the shared session within the XR application as an XR environment (either fully immersive as VR or overlaid onto a view of the real-world environment as MR or AR) with respect to the at least one spatial anchor included in the session data. Upon launch of the XR application, shared session rendering module 440 can analyze the real-world environment and find the points corresponding to the spatial anchors that were previously defined, and render the XR environment (including virtual objects) persistently with respect to those points. A similar module on the other XR device can similarly render the shared session within the XR application as an XR environment with respect to the spatial anchors included in the session data. Because the spatial anchors are common for both XR devices, both XR devices can use the spatial anchors as common reference points, and both users of both XR devices can see virtual objects in the same positions with respect to the spatial anchors. Although described herein as relating to two XR devices joining a shared session, however, it is contemplated that any number of co-located XR devices can join the shared session. Further details regarding rendering a shared session within an XR application as an XR environment with respect to spatial anchors are described herein with respect to block 508 of FIG. 5.

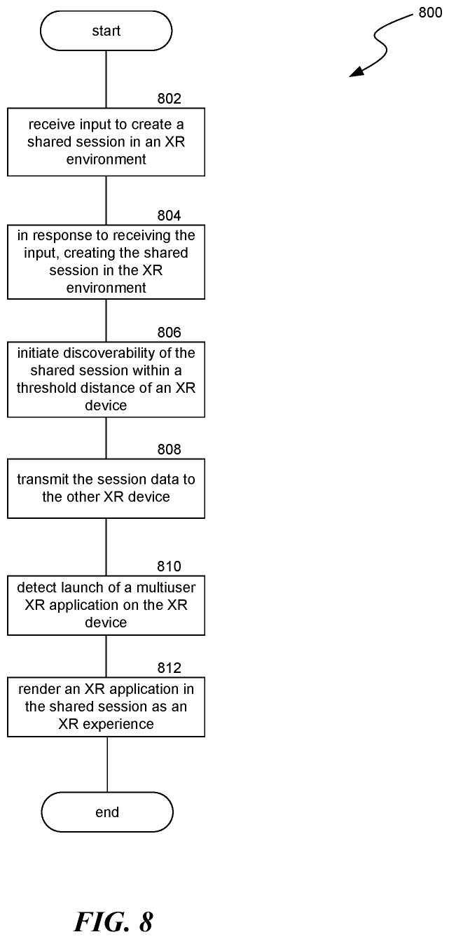

Input receipt module 442 can receive input to create a shared session in an XR environment from a user via an XR device. In some implementations, input receipt module 442 can receive the input from a user, e.g., based on selection of a virtual button corresponding to creating a shared session. In some implementations, the user can select the virtual button by making a gesture toward the virtual button (e.g., a point-and-tap gesture at the displayed location of the virtual button, as captured by one or more cameras integral with or in operable communication with the XR device). In some implementations, the user can select the virtual button via a virtual ray casted from one or more controllers in operable communication with the XR device (e.g., controller 276A and/or controller 276B of FIG. 2C). In some implementations, input receipt module 442 can receive automatically generated input, such as when the XR device detects a co-located or proximate XR device (e.g., through a proximity sensor). Further details regarding receiving input to create a shared session in an XR environment from a user via an XR device are described herein with respect to block 802 of FIG. 8.

Shared session creation module 444 can, in response to input receipt module 442 receiving input, create a shared session in the XR environment. In some implementations, creating the shared session includes generating session data. The session data can include at least one spatial anchor. The spatial anchors can be world-locked frames of reference in a real-world environment surrounding the XR device. For example, the spatial anchors can represent points within the real-world environment that can be referenced to determine relative positions of XR devices and/or to place virtual objects at particular locations overlaid onto a view of the real-world environment. Further details regarding creating a shared session in an XR environment are described herein with respect to block 804 of FIG. 8.

Discoverability initiation module 446 can initiate discoverability of the shared session within a threshold distance of the XR device. For example, the XR device can advertise (i.e., broadcast) a set of data packets via a wireless communication protocol (e.g., Bluetooth) that can be visible to proximate devices using the same protocol. Thus, another XR device co-located with the XR device (e.g., another XR device within wireless communication range of the XR device) can discover the shared session. Further details regarding initiating discoverability of a shared session within a threshold of distance of an XR device are described herein with respect to block 806 of FIG. 8.

In some implementations, session data transmission module 436 can transmit the session data to the other XR device. Session data transmission module 436 can transmit the session data to the other XR device over any suitable network, such as network 330 of FIG. 3. In some implementations, session data transmission module 436 can transmit the session data to the other XR device over the same network in which discoverability initiation module 446 initiates discoverability of the shared session. Upon receipt of the session data, the other XR device can join the shared session. Further details regarding transmitting session data to another XR device are described herein with respect to block 808 of FIG. 8.

As described further above, XR application launch detection module 434 can detect launch of a multiuser XR application on the XR device, such as XR HMD 200 of FIG. 2A and/or XR HMD 252 of FIG. 2B. In some implementations, XR application launch detection module 434 can detect launch of the XR application based on manual user input or automatic launch of the XR application, as described further herein. Upon launch, the XR application can make API calls to XR application launch detection module 434 to discover the shared session. Further details regarding detecting launch of an XR application on an XR device are described herein with respect to block 810 of FIG. 8.

As described further above, shared session rendering module 440 can render the XR application in the shared session as an XR experience (either fully immersive, as in virtual reality (VR), or overlaid onto a view of the real-world environment, as in mixed reality (MR) or augmented reality (AR)), with respect to spatial anchors included in the session data. Upon launch of the XR application, shared session rendering module 440 can render the XR experience (including virtual objects) persistently with respect to the spatial anchors. A similar module on the other XR device can similarly render the shared session within the XR application as an XR environment with respect to the spatial anchors included in the session data. Further details regarding rendering an XR application in a shared session as an XR experience are described further herein with respect to block 812 of FIG. 8.

Although described herein as including all of XR application launch detection module 434, session data transmission module 436, session identifier broadcast module 438, shared session rendering module 440, input receipt module 442, shared session creation module 444, and discoverability initiation module 446, it is contemplated that one or more of such modules can be omitted from specialized components 430 in some implementations. For example, for application-level shared session creation, specialized components 430 can omit input receipt module 442, shared session creation module 444, and discoverability initiation module 446. In another example, for system-level shared session creation, specialized components 430 can omit session data transmission module 436 and session identifier broadcast module 438.

Those skilled in the art will appreciate that the components illustrated in FIGS. 1-4 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 5 is a flow diagram illustrating a process 500 used in some implementations for establishing a shared session for an artificial reality (XR) application on an application level. In some implementations, process 500 can be performed upon launch of a multiuser XR application on an XR device, the XR application being configured to establish a shared session. In some implementations, process 500 can be performed upon launch of an XR application on an XR device, and upon detection and/or discovery of a co-located XR device. In some implementations, some or all of process 500 can be performed on an XR device, such as an XR head-mounted display (HMD) (e.g., XR HMD 200 of FIG. 2A and/or XR HMD 252 of FIG. 2B). In some implementations, some or all of process 500 can be performed on another device within an XR system in operable communication with an XR HMD, such as external processing components.

At block 502, process 500 can detect launch of a multiuser XR application on an XR device of a user. Process 500 can detect launch of the XR application based on, for example, user input to launch the XR application. The user input can be, for example, a selection of a virtual button corresponding to the XR application from a menu, such as by a gesture with the hand detected by the XR device, and/or by selection of the virtual button via a controller (e.g., controller 276A and/or controller 276B). In some implementations, process 500 can detect an automatic launch of the XR application, such as when the user of the XR device enters a particular physical space associated with the XR application. For example, the XR device can automatically launch an XR workspace application upon recognition of a desk, or launch an XR boxing application upon detection of the user entering a physical space in which the XR boxing application was last accessed. With respect to virtual reality (VR), further details regarding automatic or prompted launch of a VR application on an XR device based on location or object recognition are described in U.S. patent application Ser. No. 18/159,312, filed Jan. 25, 2023, entitled “Artificial Reality Entry Spaces for Virtual Reality Experiences” (Attorney Docket No. 3589-0211US01), which is herein incorporated by reference in its entirety.

The XR application can create a shared session within the XR application for the XR device. As used herein, a “session” can be a time-limited synchronous co-located instance of a shared experience, e.g., within an XR application. In some implementations, the XR application can automatically create the shared session upon detection of a co-located XR device (e.g., using Bluetooth detection). A “shared session” can be any content experience that is engaged by two or more users. The experience can be synchronous, asynchronous, co-located, remote-present, or any combination thereof. In some implementations, the XR application can prompt the XR device to create the shared session. In some implementations, as part of creating the shared session, process 500 can automatically obtain one or more spatial anchors upon launch of the XR application. In some implementations, the one or more spatial anchors can be included in the session data. The spatial anchors can be world-locked frames of reference that can be created at particular positions and orientations to position content at consistent points in an XR experience. Spatial anchors can be persistent across different sessions of an XR experience, such that a user can stop and resume an XR experience, while still maintaining content at the same locations in the real-world environment.

In some implementations, the spatial anchors can be stored locally on the XR device. However, because the user can use the XR device in many different locations in the real-world environment (e.g., multiple rooms in a home, other people's homes, etc.), a large number of spatial anchors may need to be stored to consistently render content at those locations. Due to the storage constraints on an XR device, some created spatial anchors often cannot be retained locally. Thus, in some implementations, the spatial anchors can be stored on a platform computing system on a cloud. The user of the XR device (or another user on the XR device or another XR device) can use the XR device to create, capture, and/or access locally cached spatial anchors at locations in the real-world environment, then upload those spatial anchors to the platform computing system.

The platform computing system can align the uploaded spatial anchors on a localization map, query a database for preexisting spatial anchors for the real-world environment (e.g., that are proximate to the XR device), and transmit the preexisting spatial anchors back to the XR device. The XR device can then render the XR application in the real-world environment using the uploaded spatial anchors and the preexisting spatial anchors, without having to itself capture and persistently store all of the spatial anchors needed to render the XR application. Thus, some implementations can conserve storage space on an XR device. Further, by storing unnecessary or infrequently used spatial anchors on a cloud, the XR device can locally store larger amounts of data needed render the XR application, improving latency and processing speed on the XR device. Further details regarding obtaining spatial anchors are described in U.S. patent application Ser. No. 18/068,918, filed Dec. 20, 2022, entitled, “Coordinating Cloud and Local Spatial Anchors for an Artificial Reality Device” (Attorney Docket No. 3589-0202US01), which is herein incorporated by reference in its entirety.

In some implementations, as part of creating the shared session, process 500 can capture scene data for the real-world environment surrounding the XR device. In some implementations, the scene data can be included in the session data in relation to one or more of the spatial anchors defined for that area. For example, the XR device can scan the area in the real-world environment to specify object locations and types within a defined scene lexicon (e.g., desk, chair, wall, floor, ceiling, doorway, etc.). This scene identification can be performed, e.g., through a user manually identifying a location with a corresponding object type or with a camera to capture images of physical objects in the scene and use computer vision techniques to identify the physical objects as object types. The system can then store the object types in relation to one or more of the spatial anchors defined for that area. Further details regarding capturing scene data are described in U.S. patent application Ser. No. 18/069,029, filed Dec. 20, 2022, entitled “Shared Scene Co-Location for Artificial Reality Devices” (Attorney Docket No. 3589-0205US01), which is herein incorporated by reference in its entirety.

In some implementations, as part of creating the shared session, process 500 can capture or create guardian data for the real-world environment surrounding the XR device. In some implementations, the guardian data can be included in the session data in relation to one or more of the spatial anchors defined for that area. The guardian data can correspond to one or more labeled “safe space” boundaries in the real-world environment of the user, in which the user can move while interacting in an XR environment, such as a virtual reality (VR) environment. Thus, the XR device can provide a warning if the user reaches an edge of the boundary. In some implementations, the user of the XR device can define the guardian space in the room, such as by drawing the boundary of the floor where no physical objects exist (e.g., using their hand or a casted ray from one or more controllers, such as controller 276A and/or controller 276B of FIG. 2C).

At block 504, process 500 can transmit session data to a platform computing system. In some implementations, process 500 can generate and transmit the session identifier with the session data. In some implementations, the session identifier can be a random string of characters, such that no personal or identifying data is disclosed to the platform computing system or intermediary devices when the session data is transmitted. In some implementations, the session data can include an application identifier set by the XR application. The application identifier can identify an instance in which process 500 launched the XR application. In some implementations, the session data can include the at least one spatial anchor for the real-world environment of the user surrounding the XR device. The platform computing system can store the session data in association with a session identifier. In some implementations, process 500 can generate the session identifier and provide it to the platform computing system, while in other implementations, the platform computing system can generate the session identifier and transmit the session identifier back to the XR device.

At block 506, process 500 can, in response to a call by the XR application, broadcast the session identifier via a wireless signal transmission. A coverage area of the wireless signal transmission can be a threshold distance surrounding the XR device in a real-world environment. In some implementations, process 500 can broadcast the session identifier automatically upon detection that another XR device is within the threshold distance of the XR device, such as by Bluetooth detection, using a WiFi fingerprint, using a nearby or same network, IP communication, etc. In some implementations, process 500 can broadcast the session identifier based on selection of a prompt on the XR device to broadcast the session identifier. In some implementations, process 500 can display the prompt upon detection that another XR device is within the threshold distance of the XR device. In some implementations, broadcasting the session identifier can include specifying that the other XR device can discover the session identifier, e.g., process 500 can only broadcast the session identifier and/or can only transmit the session identifier to the other XR device based on an access list of XR devices that are allowed to discover the shared session and/or can encrypt or otherwise protect the session identifier so only devices with an appropriate key or other credential (i.e., devices provided a key due to having certain account access or defined relationship—such as friends on a social media network—with the user of the sending XR device) can access the session identifier. In other words, process 500 can broadcast the session as public (i.e., open to anyone), private (i.e., only open to certain people, such as registered friends of the user of the XR device), or custom (i.e., only selected users).

The other XR device, within the threshold distance of the XR device, can discover the broadcasted session identifier, retrieve the session data from the platform computing system using the discovered session identifier, and join the shared session using the retrieved session data. In some implementations, the session data can include spatial anchors for the real-world environment in which the XR device and the other XR device are co-located, which were either captured by the XR device and uploaded to the platform computing system, accessed locally by the XR device and uploaded to the platform computing system, and/or previously stored on the platform computing system and downloaded to the XR device. In some implementations, the other XR device can obtain the spatial anchors directly from the XR device. In some implementations, the other XR device can itself capture and/or locally access one or more spatial anchors for the real-world environment, and upload the captured and/or locally accessed spatial anchors to the platform computing system. The platform computing system can then locate and provide one or more preexisting spatial anchors to the other XR device. Further details regarding obtaining spatial anchors are described in U.S. patent application Ser. No. 18/068,918, filed Dec. 20, 2022, entitled “Coordinating Cloud and Local Spatial Anchors for an Artificial Reality Device” (Attorney Docket No. 3589-0202US01), which is herein incorporated by reference in its entirety.

In some implementations, the session data obtained by the other XR device can include scene data for the real-world environment captured by the XR device. The other XR device can obtain the scene data either from the platform computing system or from the XR device. The other XR device can then render virtual objects with respect to the physical objects using the scene data (e.g., as an augmented reality (AR) or mixed reality (MR) experience), without having to rescan the scene for the physical objects itself, resulting in time savings, improved efficiency, and lower processing requirements for the other XR device. Further details regarding capturing and receiving scene data are described in U.S. patent application Ser. No. 18/069,029, filed Dec. 20, 2022, entitled “Shared Scene Co-Location for Artificial Reality Devices” (Attorney Docket No. 3589-0205US01), which is herein incorporated by reference in its entirety.

In some implementations, the session data obtained by the other XR device can include guardian data corresponding to one or more labeled “safe space” boundaries in the real-world environment surrounding the XR device and the other XR device. For example, a user of the XR device may have previously defined (e.g., drawn) a guardian space in a room, specifying where it is safe to operate in a VR experience without colliding with real-world objects. When the user of the other XR device obtains a spatial anchor associated with a guardian, their XR device can access the associated guardian metadata and use the preexisting guardian without having to set one up—significantly increasing the ease with which the user can start an XR experience, such as a VR experience, on the other XR device.

At block 508, process 500 can render the shared session within the XR application. In some implementations, process 500 can render the shared session within the XR application as an XR environment with respect to the at least one spatial anchor included in the session data. In some implementations, the other XR device can render the shared session within the XR application as an XR environment with respect to the at least one spatial anchor included in the session data. In some implementations, the other XR device can use an application identifier in the session data to join the shared session within the same instance of the executed XR application as the XR device. In some implementations, remote users on XR devices that are not co-located with the XR device and the other XR device (e.g., remote users, remote-present users, etc.) can further join the same instance of the executed XR application.

In some implementations, process 500 can further render virtual objects, overlaid onto the real-world environment surrounding the XR device, at positions in the real-world environment relative to the spatial anchors, such as in a mixed reality (MR) or augmented reality (AR) experience. In some implementations, the positions of the virtual objects in the real-world environment as rendered by the XR device can correspond to positions of the virtual objects in the real-world environment as rendered by the other XR device, with respect to the spatial anchors. In other words, the rendered positions of the virtual objects can be the same for the XR device and the other XR device with respect to the spatial anchors. Although described herein as relating to two XR devices joining a shared session, however, it is contemplated that any number of co-located XR devices can join the shared session.

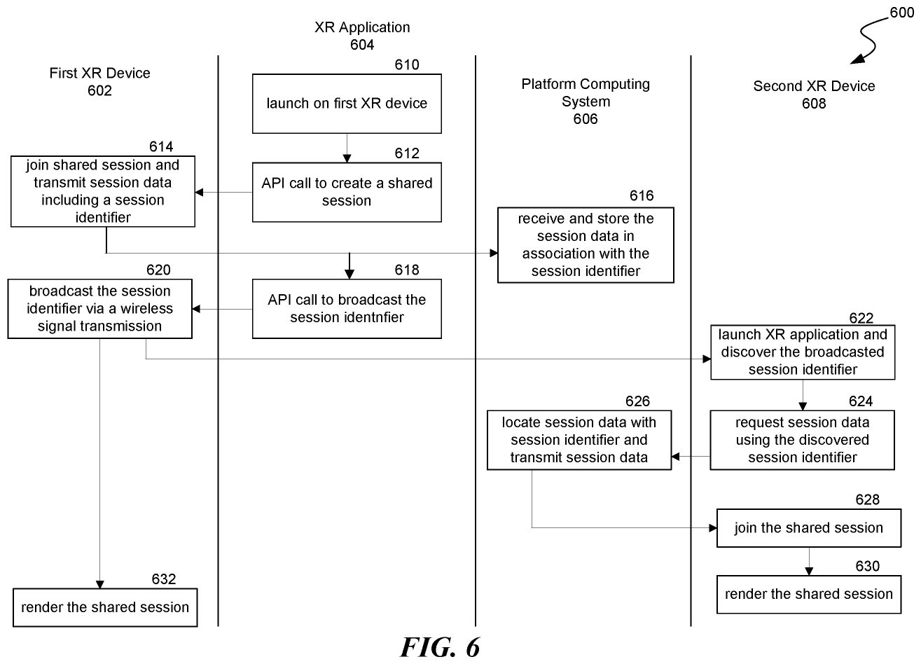

FIG. 6 is a flow diagram illustrating a process 600 performed by various components to establish and join a shared session for an artificial reality (XR) application on an application level. In some implementations, process 600 can be performed upon launch of XR application 604 on first XR device 602, the XR application being configured to establish a shared session. In some implementations, process 500 can be performed upon launch of an XR application on first XR device 602, and upon detection and/or discovery of one or more co-located XR devices, e.g., second XR device 608. Process 600 can be performed by first XR device 602 having XR application 604, platform computing system 606, and second XR device 608 having installed the same XR application as XR application 604 (not shown). In some implementations, first XR device 602 and/or second XR device 608 can be XR head-mounted displays (HMDs) (e.g., XR HMD 200 of FIG. 2A and/or XR HMD 252 of FIG. 2B). In some implementations, first XR device 602 and/or second XR device 608 can be or include one or more other devices within an XR system in operable communication with an XR HMD, such as external processing components. Although described herein as relating to two XR devices joining a shared session, however, it is contemplated that any number of co-located XR devices can join the shared session.

At block 610, XR application 604 can launch on first XR device 602. Upon launch, XR application 604 can transmit an application programming interface (API) call to create a shared session at block 612 to first XR device 602. At block 614, first XR device 602 can join the shared session and transmit session data, including a session identifier, to platform computing system 606. In some implementations, the session data can further include spatial anchors for the real-world environment. In some implementations, XR application 604 can further access the spatial anchors and automatically establish a spatial frame of reference for the real-world environment. In some implementations, XR application 604 can add spatial anchors to the shared session that can be shared with platform computing system 606. At block 616, platform computing system 606 can receive and store the session data in association with the session identifier.

At block 618, XR application 604 can make an API call to first XR device 602 to broadcast the session identifier. At block 620, first XR device 602 can broadcast the session identifier via a wireless signal transmission within a threshold distance of first XR device 602, e.g., within 5,000 square feet. At block 622, second XR device 608, which is within a coverage area of the wireless signal transmission, can launch the same XR application (not shown) and discover the broadcasted session identifier. Although not illustrated, second XR device 608 can discover the broadcasted session identifier based on an API call from the XR application installed on second XR device 608, which can be the same application as XR application 604 installed on first XR device 602. Further, second XR device 608 can return the discovered session identifier to the XR application (not shown) installed on second XR device 608.

At block 624, second XR device 608 can request the session data from platform computing system 606 using the discovered session identifier. At block 626, platform computing system 606 can locate the session data with the session identifier and transmit the session data to second XR device 608. In some implementations, platform computing system 606 can transmit the session data to second XR device 608 based on a determination that first XR device 602 and second XR device 608 are co-located. Platform computing system 606 can determine that first XR device 602 and second XR device 608 are co-located by any suitable method, such as by determining that first XR device 602 and second XR device 608 are communicating with platform computing system 606 over a same network (e.g., WiFi).

In some implementations, platform computing system 606 can determine that first XR device 602 and second XR device 608 are co-located by comparing visual features of the real-world environment captured by first XR device 602 to visual features of the real-world environment captured by second XR device 608, and determining that they are within a same scene in the real-world environment. In such implementations, first XR device 602 can capture visual features of the real-world environment with, for example, one or more cameras integral with or in operable communication with first XR device 602, and transmit such visual features with the session data to platform computing system 606 at block 614. Similarly, second XR device 608 can capture visual features of the real-world environment with, for example, one or more cameras integral with or in operable communication with second XR device 608, and transmit such visual features with the session identifier to platform computing system 606 at block 624. Platform computing system 606 can then compare the two sets of visual features to determine if they match above a threshold (e.g., by performing feature extraction, object detection, object recognition, etc.). If they match above the threshold, platform computing system 606 can determine that first XR device 602 and second XR device 608 are co-located.

At block 626, platform computing system 606 can locate the session data with the session identifier and transmit the session data to second XR device 608. At block 628, second XR device 608 can join the shared session using the session data. In some implementations, second XR device 608 can join the shared session upon selection of a prompt or option to join the shared session. In some implementations, second XR device 608 can join the shared session automatically upon launch of the XR application at block 622 and upon detection of second XR device 608 in proximity to first XR device 602. At block 630, second XR device 608 can render the shared session, and at block 632, first XR device 602 can render the shared session. Using the session data (e.g., spatial anchors, scene data, guardian data, etc.), second XR device 608, in some implementations, should not have to re-draw and re-establish the play space for the multiuser XR application. In some implementations, first XR device 602 and second XR device 608 can render a same instance of an XR experience within the XR application in the shared session using the same spatial anchors. Thus, in a mixed reality (MR) or augmented reality (AR) experience, the same virtual objects can be overlaid onto the real-world environment at the same positions within the real-world environment. In some implementations, second XR device 608 can move outside the threshold distance of first XR device 602 and continue within the shared session as a remote-present participant. In some implementations, first XR device 602, second XR device 608, and/or any other XR devices within the shared session can leave the shared session and have the session continue with the remaining participants, as long as there is at least one participant left in the shared session.

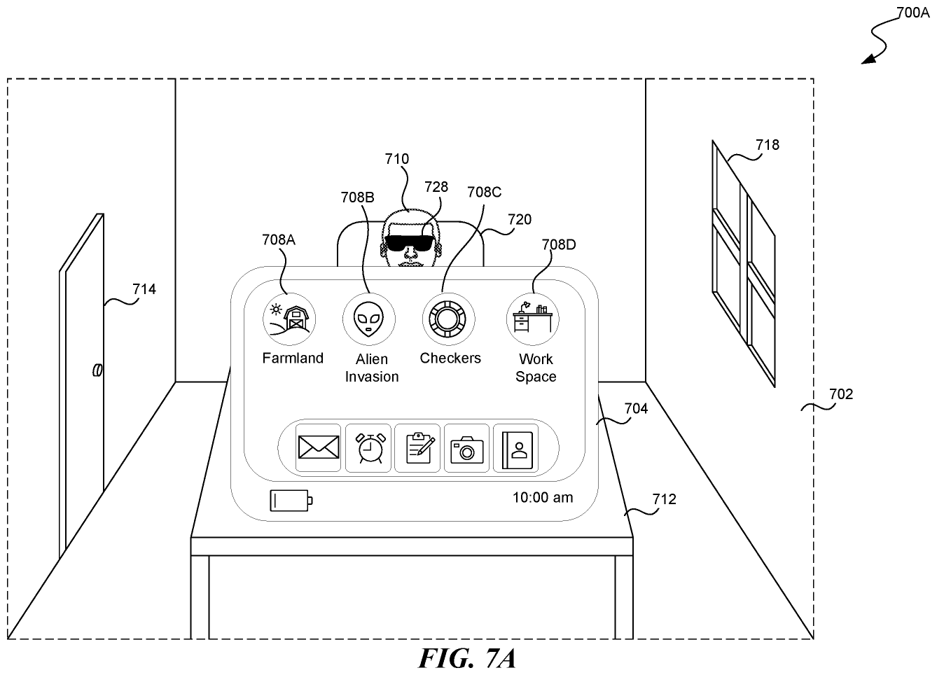

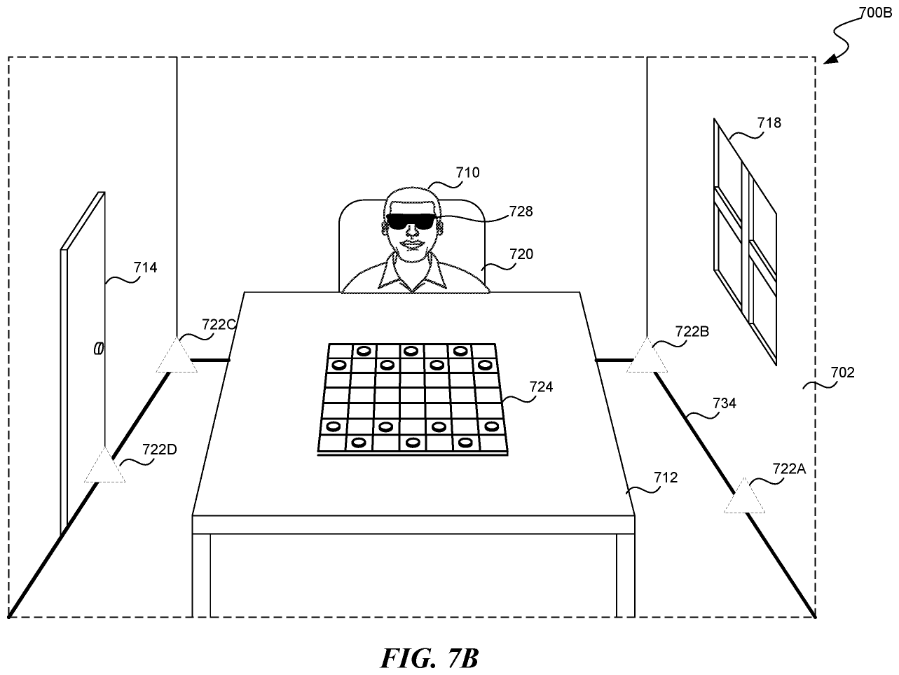

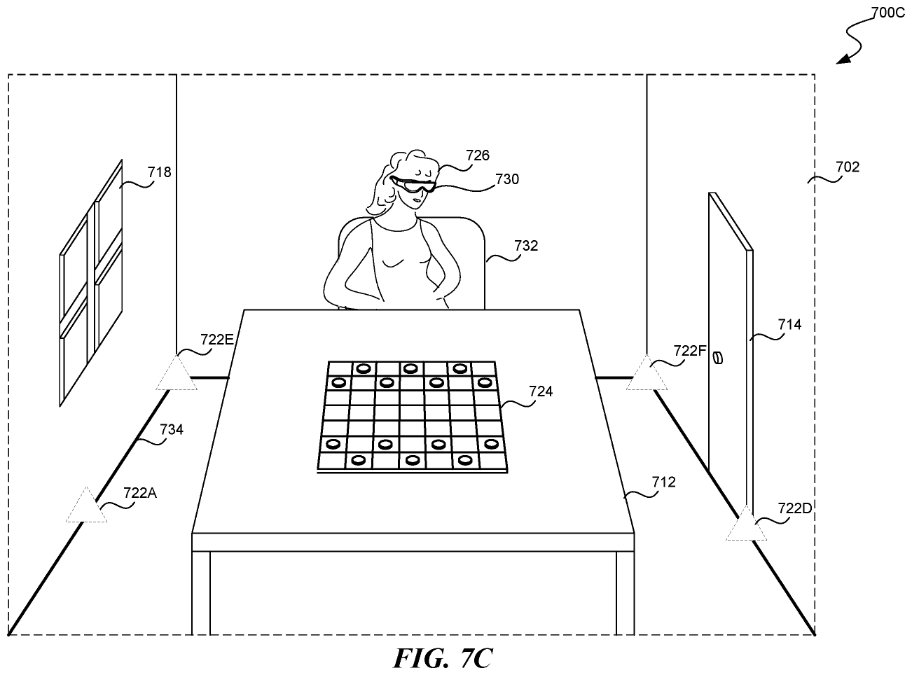

FIG. 7A is a conceptual diagram illustrating an example view 700A on a first artificial reality (XR) device 730 (shown in FIG. 7C) of a menu 704 of launchable artificial reality (XR) applications 708A-708D overlaid on a view of a real-world environment 702, such as in mixed reality (MR) or augmented reality (AR). First user 726 of first XR device 730 can be co-located with second user 710 of second XR device 728 in real-world environment 702. Real-world environment 702 can have visual features, such as table 712, door 714, window 718, and chair 720, which can also be seen by second user 710 through second XR device 728. From menu 704, first user 726 of first XR device 730 can select one of XR applications 708A-708D to launch, such as by making a gesture toward one of XR applications 708A-708D with her hand, selecting one of XR applications 708A-708D with a controller (e.g., controller 276A and/or controller 276B of FIG. 2C), etc. In the example of FIGS. 7A-7C, first user 726 of first XR device 730 can select XR application 708C corresponding to an XR checkers game.

FIG. 7B is a conceptual diagram illustrating an example view 700B on a first artificial reality (XR) device 730 (shown in FIG. 7C) of a launched XR application 708C overlaid on a view of a real-world environment 702. Upon launch of XR application 708C, XR application 708C can make an application programming interface (API) call to create a shared session. In some implementations, XR application 708C can make the API call to create the shared session based on detection of second XR device 728 of second user 710 within a threshold distance of first XR device 730 (e.g., within the same room). First XR device 730 can generate session data, including spatial anchors 722A-722D and spatial anchors 722E-F (shown in FIG. 7C), as well as a unique session identifier in some implementations. In some implementations, XR application 708C can make an API call to the operating system of first XR device 730 to capture one or more of spatial anchors 722A-722F in real-world environment 702. In some implementations, first XR device 730 can access one or more of spatial anchors 722A-722F that are locally stored or cached. In some implementations, first XR device 730 can obtain one or more of spatial anchors 722A-722F from a cloud, such as a platform computing system, as described further herein. In some implementations, the session data can further include scene data captured by first XR device 730 regarding physical objects in real-world environment 702 (e.g., table 712, door 714, window 718, chair 720), as described further herein. In some implementations, the session data can further include guardian data captured by first XR device 730 regarding a guardian 734 (e.g., boundary) within real-world environment 702. First XR device 730 can transmit the session data to the platform computing system.

XR application 708C can make an API call to the operating system of the first XR device to broadcast the session identifier via a wireless signal transmission, such as Bluetooth, Bluetooth Low Energy (BLE), near field communication (NFC), WiFi, etc. Second XR device 728 can be within a coverage area of the wireless signal transmission and can discover the broadcasted session identifier. Second XR device 728 can use the session identifier to obtain the session data from the platform computing system, which, in some implementations, can include spatial anchors 722A-722F. In some implementations, second XR device 728 can obtain spatial anchors 722A-722F (as well as scene data and guarding data in some implementations) directly from first XR device 730. First XR device 730 can then render XR application 708C, including virtual checkerboard 724, with reference to spatial anchors 722A-722F. In some implementations, first XR device 730 can further render virtual checkerboard 724 with respect to scene data (related to table 712, door 714, window 718, chair 720) and/or guardian data related to guardian 734.

FIG. 7C is a conceptual diagram illustrating an example view 700C on a second artificial reality (XR) device 728 of a launched XR application 708C in a shared session with a first XR device 730. As shown in view 700C from second XR device 728, second XR device 728 can also render XR application 708C, including virtual checkerboard 724, with reference to spatial anchors 722A-722F shared with second XR device 728 by the platform computing system or by first XR device 730. In some implementations, the second XR device 728 can further render virtual checkerboard 724 with respect to scene data (related to table 712, door 714, window 718, chair 720, chair 732) and/or guardian data related to guardian 734, obtained from the platform computing system or from first XR device 730. First XR device 730 can render virtual checkerboard 724 at the same position in real-world environment 702 relative to spatial anchors 722A-722F as second XR device 728.

FIG. 8 is a flow diagram illustrating a process 800 used in some implementations of the present technology for establishing a shared session in an artificial reality (XR) environment on a system level. As opposed to process 600 of FIG. 6, in which an XR application establishes a shared session, process 800 can establish the shared session by the system on an XR device. In some implementations, process 800 can be performed upon activation or donning of an XR device. In some implementations, process 800 can be performed upon receipt of input to create a shared session with a co-located XR device. In some implementations, some or all of process 800 can be performed on an XR device, such as an XR head-mounted display (HMD) (e.g., XR HMD 200 of FIG. 2A and/or XR HMD 252 of FIG. 2B). In some implementations, some or all of process 800 can be performed on another device within an XR system in operable communication with an XR HMD, such as external processing components.

At block 802, process 800 can receive input to create a shared session in the XR environment. The input can be, for example, a selection of a virtual button corresponding to creating a shared session from a menu, such as by a gesture with the hand detected by the XR device, and/or by selection of the virtual button via a controller (e.g., controller 276A and/or controller 276B of FIG. 2C). In some implementations, process 800 can prompt the XR device to create a shared session in the XR environment upon detection of a co-located XR device, such as by detecting a Bluetooth or near field communication (NFC) signal broadcasted by one or more other XR devices. In some implementations, the input can be automatically generated by the XR device upon detection of a co-located XR device, e.g., upon the XR device coming within a coverage area of a wireless signal transmitted by another XR device.

At block 804, process 800 can, in response to receiving the input, create the shared session in the XR environment. Creating the shared session can include generating session data, such as a session identifier, an application identifier, spatial anchors, scene data, guardian data, etc. In some implementations, as part of creating the shared session, process 800 can automatically obtain one or more spatial anchors upon creation of the shared session. The spatial anchors can be world-locked frames of reference that can be created at particular positions and orientations to position content at consistent points in an XR experience. The spatial anchors can be persistent across different sessions of the XR experience, such that a user can stop and resume an XR experience, while still maintaining content at the same locations in the real-world environment. In some implementations, process 800 can capture the spatial anchors by creating or establishing the spatial anchors in the real-world environment with respect to locations in the real-world environment. In some implementations, process 800 can capture the spatial anchors by accessing locally stored or cached spatial anchors of the real-world environment. In some implementations, process 800 can obtain one or more preexisting spatial anchors for the real-world environment using captured spatial anchors, as is described further in U.S. patent application Ser. No. 18/068,918, filed Dec. 20, 2022, entitled “Coordinating Cloud and Local Spatial Anchors for an Artificial Reality Device” (Attorney Docket No. 3589-0202US01), which is herein incorporated by reference in its entirety.

At block 806, process 800 can initiate discoverability of the shared session within a threshold distance of the XR device. Process 800 can initiate discoverability of the shared session by, for example, broadcasting a session identifier using a wireless signal transmission, such as Bluetooth, near field communication (NFC), WiFi, etc. Another XR device, within the threshold distance of the XR device, can discover the shared session through proximity detection of the wireless signal transmission. For example, the other XR device can receive the broadcasted session identifier via the wireless signal transmission, and accept or initiate a communication pathway between the devices. In some implementations, the user of the XR device can be in control of the discoverability of the shared session. For example, the user of the XR device can set up an access list of XR devices that are allowed to discover the shared session, such as through a list of device identifiers. In some implementations, the access list can specify a period of validity and/or an expiration date for access by particular XR devices.

At block 808, process 800 can transmit the session data to the other XR device. In some implementations, the session data can include a session identifier set by the XR device. The session identifier can uniquely identify the session in which the XR device and the other XR device can join and travel between XR applications, while ensuring that they stay together in the same instance within XR experiences. In some implementations, the session data can include spatial anchors for the real-world environment captured, locally stored, or obtained from the cloud by the XR device. In some implementations, however, the other XR device can itself capture spatial anchors, obtain locally stored spatial anchors, and/or obtain spatial anchors from the cloud. For example, the other XR device can capture a localization map including spatial anchors of a real-world environment, with the spatial anchors corresponding to locations in the real-world environment. The other XR device can upload the captured localization map including the spatial anchors to a platform computing system remote from the other XR device. The platform computing system can merge the captured localization map including the uploaded spatial anchors with a preexisting localization map including preexisting spatial anchors for the real-world environment maintained by the platform computing system. The platform computing system can select a subset of the preexisting spatial anchors for the other XR device based, at least in part, on a determined location within the preexisting localization map of the other XR device. The other XR device can receive at least a portion of the preexisting localization map including the subset of preexisting spatial anchors. Upon receipt of the session data and the spatial anchors, the other XR device can join the shared session. Further details regarding obtaining spatial anchors are described in U.S. patent application Ser. No. 18/068,918, filed Dec. 20, 2022, entitled “Coordinating Cloud and Local Spatial Anchors for an Artificial Reality Device” (Attorney Docket No. 3589-0202US01), which is herein incorporated by reference in its entirety. In some implementations, the session data can further include scene data and/or guardian data stored with reference to the spatial anchors, as described further herein.

At block 810, process 800 can detect launch of a multiuser XR application on the XR device. Process 800 can detect launch of the XR application based on, for example, user input to launch the XR application. The user input can be, for example, a selection of a virtual button corresponding to the XR application from a menu or prompt, such as by a gesture with the hand detected by the XR device, and/or by selection of the virtual button via a controller (e.g., controller 276A and/or controller 276B of FIG. 2C). In some implementations, process 500 can detect an automatic launch of the XR application, such as when the user of the XR device enters a particular physical space associated with the XR application, has a particular physical object within view, etc. For example, the XR device can automatically launch an XR workspace application upon entering an office, launch an XR movie upon detection of the user entering a guardian of a couch, or launch an XR experience that was last accessed in a particular space while picking up where the user left off. With respect to virtual reality (VR), further details regarding automatic or prompted launch of a VR application on an XR device based on location or object recognition are described in U.S. patent application Ser. No. 18/159,312, filed Jan. 25, 2023, entitled “Artificial Reality Entry Spaces for Virtual Reality Experiences” (Attorney Docket No. 3589-0211US01), which is herein incorporated by reference in its entirety. The multiuser XR application can make an application programming interface (API) call to process 800 to discover the shared session upon launch.

At block 812, process 800 can render the multiuser XR application in the shared session as an XR experience with respect to spatial anchors for the real-world environment. The other XR device can also render the multiuser XR application in the shared session as an XR experience with respect to spatial anchors for the real-world environment. In some implementations, process 800 and the other XR can render the multiuser XR application with respect to guardians and scene data when stored in association with the spatial anchors. Because the shared session was established by the system, it is not application dependent. Thus, users of the XR device and the other XR device can travel across different XR applications together, without having to recreate sessions and reshare spatial anchors for each application. Although described herein as relating to two XR devices joining a shared session, however, it is contemplated that any number of co-located XR devices can join the shared session.

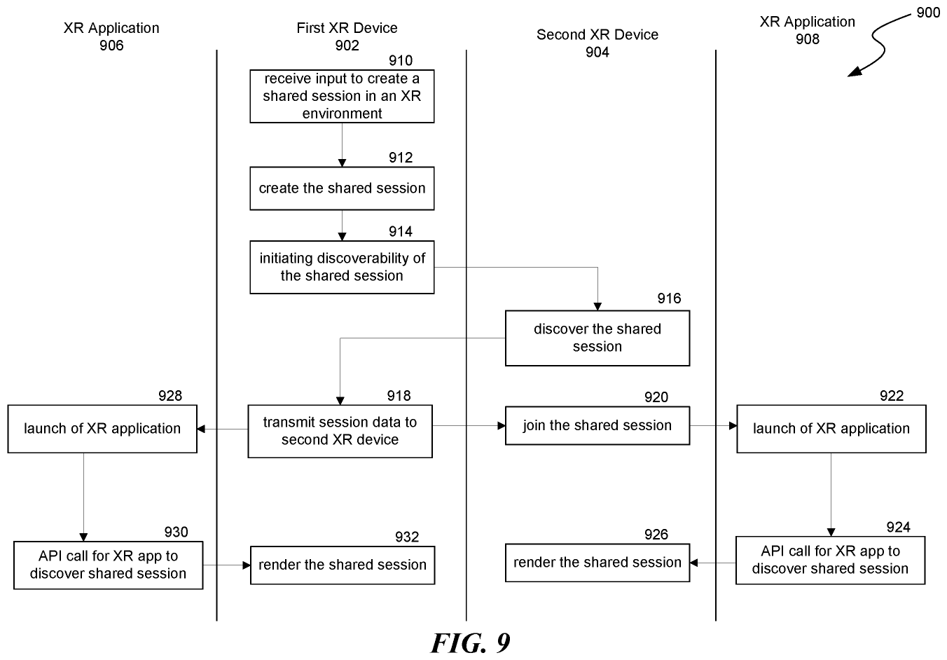

FIG. 9 is a flow diagram illustrating a process 900 performed by various components to establish and join a shared session in an artificial reality (XR) environment on a system level. In some implementations, process 900 can be performed upon activation or donning of first XR device 902. In some implementations, process 900 can be performed upon receipt of input to create a shared session in the XR environment with one or more co-located XR devices, e.g., second XR device 904. Process 900 can be performed by first XR device 902 having XR application 906, and second XR device 904 having installed XR application 908. XR application 906 and XR application 908 can be the same XR application installed on different devices. In some implementations, first XR device 902 and/or second XR device 904 can be XR head-mounted displays (HMDs) (e.g., XR HMD 200 of FIG. 2A and/or XR HMD 252 of FIG. 2B). In some implementations, first XR device 902 and/or second XR device 904 can include one or more other devices within an XR system in operable communication with an XR HMD, such as external processing components. Although described herein as relating to two XR devices joining a shared session, however, it is contemplated that any number of co-located XR devices can join the shared session.

At block 910, first XR device 902 can receive input to create a shared session in an XR environment. The input can be received, for example, via user selection of a virtual button corresponding to creating a shared session. The virtual button can be included in a menu, on a prompt to create a shared session upon detection of second XR device 904 in proximity to first XR device 902 (e.g., via Bluetooth), etc. The user can select the virtual button by, for example, making a gesture with his hand (e.g., a point-and-click motion toward the virtual button), selecting the virtual button via a virtual ray casted from a controller (e.g., controller 276A and/or controller 276B of FIG. 2C), etc.

At block 912, first XR device 902 can create the shared session, and at block 914, first XR device 902 can initiate discoverability of the shared session. In some implementations, first XR device 902 can control discoverability of the shared session, such as by allowing all proximate XR devices to discover the shared session, or limiting discoverability to only certain other XR devices, such as through the use of device identifiers. At block 916, second XR device 904 can discover the shared session. In some implementations, second XR device 904 can be discover and/or be notified of the shared session when present anywhere in the real-world environment within a threshold distance of first XR device 902 (e.g., within a wireless coverage area of 1,000 square feet, such as within a same room, within a same household, etc.), even if second XR device 904 does not have XR application 908 already installed. At block 918, first XR device 902 can transmit session data to second XR device 904. At block 920, second XR device 904 can join the shared session. In some implementations, when joining the shared session, second XR device 904 does not have to re-draw and re-establish the play space, such as when the session data includes guardian data as described herein. In some implementations in which second XR device 904 does not already have XR application 908 already installed, second XR device 904 can be prompted to download XR application 908.

At block 922, XR application 908 can launch on second XR device 904. At block 924, XR application 908 can make an application programming interface (API) call for XR application 908 to discover the shared session to second XR device 904. At block 926, second XR device 904 can render the shared session. Meanwhile, at block 928, XR application 906 can launch on first XR device 902. At block 930, XR application 906 can make an API call for XR application 906 to discover the shared session to first XR device 902. At block 932, first XR device 902 can render the shared session within XR application 906. In some implementations, first XR device 902 and second XR device 904 can stay within the shared session while moving about the real-world environment, even when outside proximity detection of each other. In such implementations, for example, if second XR device 904 moves outside a threshold distance from first XR device 902, second XR device 904 can switch to remote-present mode and stay within the shared session. Thus, even outside of XR application 906 and XR application 908, first XR device 902 and second XR device 904 can discover sessions nearby, join, and leave discovered sessions. XR application 906 and XR application 908 can retrieve and use the shared session established by first XR device 902 and second XR device 904, respectively, but XR applications 906-908 may not end the shared session.

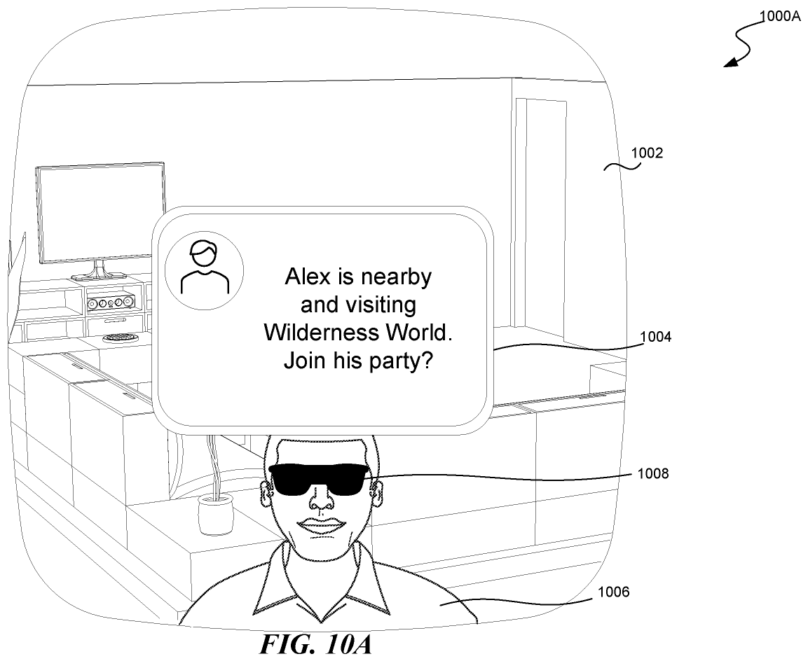

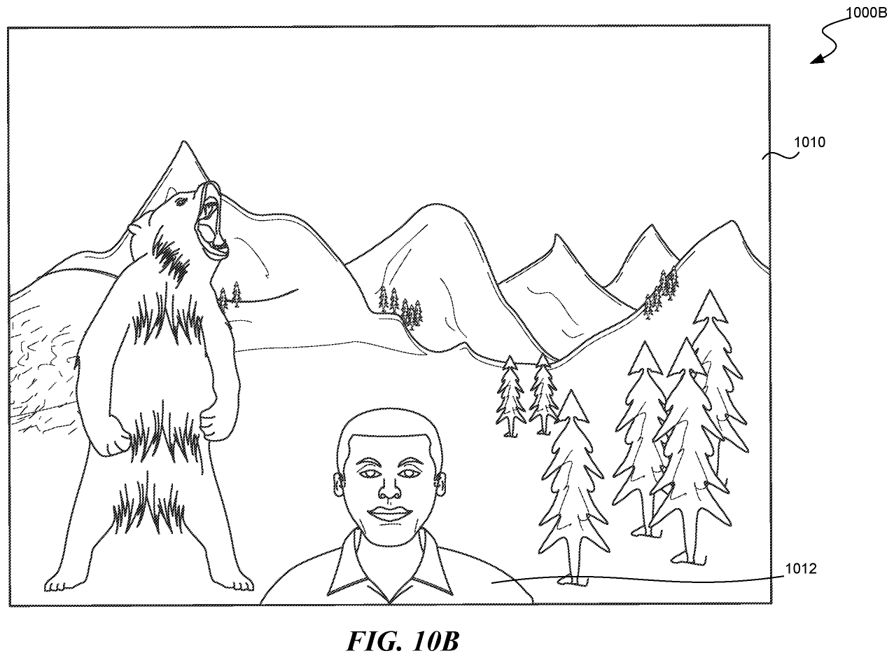

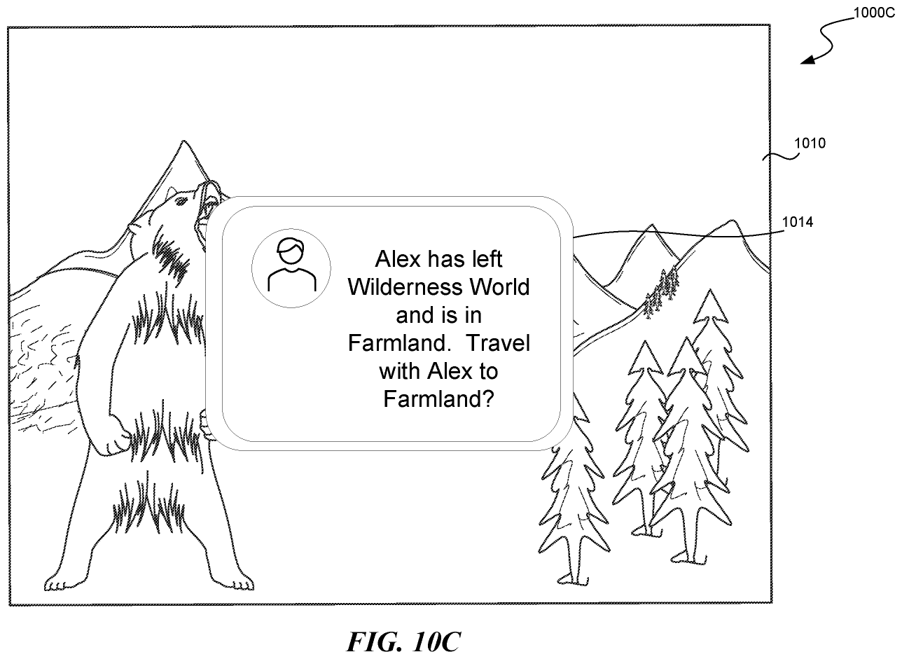

FIG. 10A is a conceptual diagram illustrating an example view 1000A on a first artificial reality (XR) device, of a first user, of a prompt 1004 to join a second user 1006, on a second XR device 1008, in an XR application (e.g., “Wilderness World”) in a shared session. Upon detection of the first XR device in proximity to second XR device 1008 (e.g., through Bluetooth detection), the first XR device can automatically display prompt 1004, overlaid onto a view of real-world environment 1002, to join second user 1006 in the XR application in the shared session. Second user 1006 could have previously created the shared session via second XR device 1008, generated session data for the XR application, and became discoverable to the co-located first user. Upon selection by the first user via the first XR device to join the shared session from prompt 1004, second XR device 1008 can transmit the session data to the first XR device, and the first XR device can join the shared session.

FIG. 10B is a conceptual diagram illustrating an example view 1000B on a first artificial reality (XR) device of a shared session in an XR application. Upon receipt of the session data, the first XR device can join the shared session with second XR device 1008. The first XR device can further launch the XR application (e.g., “Wilderness World”). Upon launch, the XR application can make a call to the system of the first XR device to discover the shared session, and place the first XR device in the shared session within the XR application. The XR application can, in some implementations, be a virtual reality (VR) experience. Thus, the first XR device can display, for example, artificial environment 1010, including an avatar 1012 of second user 1006 within the shared session.

FIG. 10C is a conceptual diagram illustrating an example view 1000C on a first artificial reality (XR) device of a prompt 1014 to travel with a second user 1006 to another XR application in a shared session. Second user 1006 can leave the XR application, “Wilderness World,” leaving only the first user within artificial environment 1010 of the XR application, and launch another XR application (e.g., “Farmland”). Because the shared session was established by second user 1006 via second XR device 1008 on a system level (as opposed to an application level), the shared session can persist across XR applications. Thus, by selecting an option to travel to the other XR application via prompt 1014, the first XR device can leave “Wilderness World,” and travel to the same instance of an XR experience within “Farmland” as second XR device 1008, without having to recreate the shared session or form a party.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative mutually implementations exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for establishing a shared session for a multiuser artificial reality application, the method comprising:
detecting launch of the multiuser artificial reality application on an artificial reality device of a user, wherein the multiuser artificial reality application creates a shared session within the multiuser artificial reality application for the artificial reality device;
transmitting session data to a platform computing system, the session data including at least one spatial anchor that comprises a world-locked frame of reference in a real-world environment surrounding the artificial reality device, wherein the platform computing system stores the session data in association with a session identifier;
in response to a call by the multiuser artificial reality application, broadcasting the session identifier via a wireless signal transmission, a coverage area of the wireless signal transmission being a threshold distance surrounding the artificial reality device in the real-world environment,
wherein an other artificial reality device, within the threshold distance of the artificial reality device, discovers the broadcasted session identifier,
wherein the other artificial reality device retrieves the session data from the platform computing system using the discovered session identifier, and
wherein the other artificial reality device joins the shared session using the retrieved session data; and
rendering the shared session within the multiuser artificial reality application as an artificial reality experience with respect to the at least one spatial anchor, wherein the other artificial reality device renders the shared session within the multiuser artificial reality application as an artificial reality experience with respect to the at least one spatial anchor.

2. The method of claim 1, further comprising:
rendering one or more virtual objects, overlaid onto the real-world environment surrounding the artificial reality device, at one or more positions in the real-world environment relative to the at least one spatial anchor,
wherein the other artificial reality device renders the one or more virtual objects at the one or more positions in the real-world environment relative to the at least one spatial anchor.

3. The method of claim 1, wherein the platform computing system transmits the session data to the other artificial reality device based on a determination that the artificial reality device and the other artificial reality device are co-located, the determination being made by comparing one or more visual features of the real-world environment captured by the other artificial reality device to one or more visual features of the real-world environment captured by the artificial reality device.

4. The method of claim 1, wherein the other artificial reality device joins the shared session via selection of a prompt on the other artificial reality device.

5. The method of claim 1, wherein the other artificial reality device joins the shared session automatically upon receipt of the session data.

6. The method of claim 1, further comprising:
detecting that the other artificial reality device is within the threshold distance of the artificial reality device,
wherein the session identifier is broadcasted in response to selection of a prompt on the artificial reality device, the prompt being displayed in response to detection that the other artificial reality device is within the threshold distance of the artificial reality device.

7. The method of claim 1, further comprising:
detecting that the other artificial reality device is within the threshold distance of the artificial reality device,
wherein the session identifier is broadcasted automatically in response to detection that the other artificial reality device is within the threshold distance of the artificial reality device.

8. The method of claim 1, wherein the session identifier is provided with security protections and wherein the security protections allow the other artificial reality device to access the session identifier due to a defined relationship, on a social medial platform, between a user of the artificial reality device and a user of the other artificial reality device.

9. The method of claim 1, further comprising:
obtaining the session identifier from the platform computing system, the platform computing system generating the session identifier, at least partially, as a random string of characters.

10. The method of claim 1, further comprising:
extracting an application identifier set by the multiuser artificial reality application,
wherein the application identifier identifies an instance in which the artificial reality device is accessing the multiuser artificial reality application,
wherein the session data includes the application identifier, and
wherein the other artificial reality device joins the shared session within the instance of the multiuser artificial reality application based on the application identifier.

11. The method of claim 1, wherein the artificial reality device automatically obtains the at least one spatial anchor upon creation of the shared session.

12. The method of claim 1, wherein the session data further includes guardian data, the guardian data defining boundaries in the real-world environment in which the artificial reality device and the other artificial reality device are permitted to access the multiuser artificial reality application.

13. The method of claim 1, wherein broadcasting the session identifier, within the threshold distance of the artificial reality device in the real-world environment, includes transmitting the session identifier to the other artificial reality device based on a determination that the other artificial reality device is on an access list of one or more permitted artificial reality devices.

14. A computer-readable storage medium storing instructions that, when executed by a computing system, cause the computing system to perform a process for establishing a shared session for an artificial reality application, the process comprising:
detecting launch of the artificial reality application on an artificial reality device of a user, wherein the artificial reality application creates a shared session;
transmitting session data, to a platform computing system, in association with a session identifier;
in response to a call by the artificial reality application, broadcasting the session identifier, via a wireless signal transmission, in a coverage area of the wireless signal transmission surrounding the artificial reality device in a real-world environment,
wherein an other artificial reality device, within the coverage area , discovers the broadcasted session identifier,
wherein the other artificial reality device retrieves the session data from the platform computing system using the discovered session identifier, and
wherein the other artificial reality device joins the shared session using the retrieved session data; and
rendering the shared session within the artificial reality application.

15. The computer-readable storage medium of claim 14,
wherein the session data includes at least one spatial anchor that comprises a world-locked frame of reference in the real-world environment surrounding the artificial reality device,
wherein the shared session is rendered within the artificial reality application as an artificial reality experience with respect to the at least one spatial anchor, and
wherein the other artificial reality device renders the shared session within the artificial reality application as an artificial reality experience with respect to the at least one spatial anchor.

16. The computer-readable storage medium of claim 15, further comprising:
rendering one or more virtual objects, overlaid onto the real-world environment surrounding the artificial reality device, at one or more positions in the real-world environment relative to the at least one spatial anchor,
wherein the other artificial reality device renders the one or more virtual objects at the one or more positions in the real-world environment relative to the at least one spatial anchor.

17. The computer-readable storage medium of claim 14, wherein the platform computing system transmits the session data to the other artificial reality device based on a determination that the artificial reality device and the other artificial reality device are co-located, the determination being made by comparing one or more visual features of the real-world environment captured by the other artificial reality device to one or more visual features of the real-world environment captured by the artificial reality device.

18. A computing system for establishing a shared session for an artificial reality application, the computing system comprising:
one or more processors; and
one or more memories storing instructions that, when executed by the one or more processors, cause the computing system to perform a process comprising:
detecting launch of the artificial reality application on an artificial reality device of a user, wherein the artificial reality application creates a shared session;
transmitting session data, to a platform computing system, in association with a session identifier;
in response to a call by the artificial reality application, broadcasting the session identifier, via a wireless signal transmission, in a coverage area of the wireless signal transmission surrounding the artificial reality device in a real-world environment,
wherein an other artificial reality device, within the coverage area , discovers the broadcasted session identifier,
wherein the other artificial reality device retrieves the session data from the platform computing system using the discovered session identifier, and
wherein the other artificial reality device joins the shared session using the retrieved session data; and
rendering the shared session within the artificial reality application.

19. The computing system of claim 18,
wherein the session data includes at least one spatial anchor that comprises a world-locked frame of reference in the real-world environment surrounding the artificial reality device,
wherein the shared session is rendered within the artificial reality application as an artificial reality experience with respect to the at least one spatial anchor, and
wherein the other artificial reality device renders the shared session within the artificial reality application as an artificial reality experience with respect to the at least one spatial anchor.

20. The computing system of claim 19, wherein the artificial reality device automatically obtains the at least one spatial anchor upon creation of the shared session.
